(19) United States
(12) Patent Application Publication
(10) Pub. No.: US 2024/0270653 A1
(43) Pub. Date: Aug. 15, 2024

(54) Manufacturing of Ultra-Lightweight Composites Through Accelerated CO2 Mineralization

(71) Applicant: PVT Clean Energy LLC, Poughkeepsie, NY (US)

(72) Inventors: Huiming Yin, Alpine, NJ (US); Mehdi Zadshir, Little Ferry, NJ (US); Frank Pao, Boston, MA (US)

(21) Appl. No.: 18/442,559

(22) Filed: Feb. 15, 2024

Related U.S. Application Data
(60) Provisional application No. 63/485,033, filed on Feb. 15, 2023.

(51) Int. Cl. C04B 38/10; C04B 18/02; C04B 18/24; C04B 20/10; C04B 38/00; C04B 40/02

(52) U.S. Cl. CPC C04B 38/103; C04B 18/021; C04B 18/027; C04B 18/241; C04B 20/1029; C04B 38/0054; C04B 40/0236

(57) ABSTRACT

A method for producing ultra-lightweight concrete (ULWC), includes: generating CO₂ foam including nanobubbles; forming a brine paste including nanocrystals and nanopores by mixing the nanobubbles with a brine solution; generating the CO₂ foam including microbubbles, where pore sizes of the microbubbles are larger than pore sizes of the nanobubbles; mixing the microbubbles into the brine paste, where the nanocrystals comprised in the brine paste distributes along a surface of each microbubble; and mixing fiber hairs into the brine paste and the microbubbles. Ultra-lightweight aggregate (ULWA) may be formed using the ULWC. A method for producing ULWC panels, includes: printing creases on alkali-resistant fiber paper sheets; folding the fiber paper sheets along the creases; affixing the folded fiber paper sheets into a 3D structure with open channels; injecting atomized brine water into surfaces of the open channels; and injecting CO₂ gas into the open channels until filled with carbonate crystals.

### CROSS-REFERENCE TO RELATED APPLICATIONS

The present application claims priority to U.S. Provisional Patent Application Ser. No. 63/485,033, entitled “Design and manufacture of an ultra-lightweight composite through accelerated CO₂ mineralization with temperature insensitive properties” and filed Feb. 15, 2023. The foregoing application is incorporated herein by reference in its entirety.

### BACKGROUND ART

Cellular and granular lattices are two common engineering materials with bonds often idealized as elastic springs and Hertz contacts. Although 3D printing can precisely control the microstructure and fabricate the materials, the manufacturing speed is relatively slow, and the costs are relevantly high. Lattice-based materials have attracted a lot of attention with the advancement of nanotechnology and three-dimensional (3D) printing. Mathematically, the lattice-based materials can be idealized by the nodes connected by bonds, which can be found in both natural and engineering materials such as cellular, granular, and crystal lattices. The lattice-based materials provide materials for lightweight structures with properties such as deformability, thermal and acoustic insulation, energy absorption, and impact protection. These materials can be used as insulation materials for building envelopes, filling materials for vehicles, vessels, and aircraft, and lightweight structure materials for terrestrial applications such as high-rise buildings as well as extraterrestrial applications in space explorations. As lattice-based materials exhibit much lower density than bulk materials due to the porosity within the material, their stiffness and strength are relatively low in comparison to bulk materials or composites without air voids. Some mechanical and structural constraints are imposed on the application of these lattice-based materials when they are subjected to thermal and mechanical loading.

Conventional foamed concrete has been used in buildings for thermal insulation. However, the performance of conventional foamed concrete, in terms of density or R-Value, cannot be comparable to the polymeric foam counterparts, such as polyurethane (PU) or polystyrene (PS). However, the use of the latter materials often brings concerns about fire safety. Further, in conventional concrete manufacturing, the ambient CO₂ concentration (˜0.04%) is too low to enable efficient CO₂ curing. Thus, practical CO₂ curing of concrete, which is called external curing, is highly dependent on a carbon chamber to provide CO₂ where the gas reacts with concrete materials through surface contact.

### SUMMARY OF THE EMBODIMENTS

In accordance with one embodiment, a method for producing ultra-lightweight concrete, includes: generating carbon dioxide (CO₂) foam including a plurality of nanobubbles; forming a brine paste including nanocrystals and nanopores by mixing the plurality of nanobubbles with a brine solution; generating the CO₂ foam including a plurality of microbubbles, where pore sizes of the plurality of microbubbles are larger than pore sizes of the plurality of nanobubbles; mixing the plurality of microbubbles into the brine paste, where the nanocrystals comprised in the brine paste distributes along a surface of each microbubble; and mixing a plurality of fiber hairs into the brine paste and the plurality of microbubbles.

In one aspect, the method further includes: cutting the ultra-lightweight concrete into balls to form a plurality of ultra-lightweight aggregate (ULWA).

In another aspect, the method further includes: polishing the ULWA into a plurality of spherical balls including the plurality of fiber hairs; placing the plurality of ULWA balls into a CO₂ chamber; sealing the plurality of ULWA balls with a polymer coating; and packaging the plurality of coated ULWA balls.

In another aspect, the method further includes: compressing the packaged plurality of coated ULWA balls.

In accordance with another embodiment, a method for producing ultra-lightweight concrete panels, includes: printing a plurality of creases on a plurality of alkali-resistant fiber paper sheets; folding the plurality of alkali-resistant fiber paper sheets along the plurality of creases; affixing the folded plurality of alkali-resistant fiber paper sheets into a three-dimensional structure with a plurality of open channels; injecting atomized brine water into surfaces of the plurality of open channels; and injecting gas comprising CO₂ into the plurality of open channels, wherein carbonation occurs to create carbonate crystals on the surfaces of the plurality of open channels.

In one aspect, the method further includes: repeating the injecting of the atomized brine water and the injecting of the gas comprising CO₂ until the plurality of open channels are filled with carbonate crystals.

### BRIEF DESCRIPTION OF THE DRAWINGS

The foregoing features of embodiments will be more readily understood by reference to the following detailed description, taken with reference to the accompanying drawings, in which:

FIG. 1 illustrates an example application of ultra-lightweight concrete (ULWC) for modular manufacturing and construction of large building panels.

FIG. 2 illustrates a flowchart for a method for producing ULWC using hierarchically CO₂ foaming.

FIG. 3 illustrates an example nanobubble.

FIG. 4 illustrates an example microbubble.

FIG. 5 illustrates a flowchart of a method for producing packaged ultra-lightweight aggregate (ULWA).

FIGS. 6A-6B illustrate applying pre-tension to a composite of ULWA balls.

FIG. 7 illustrates a flowchart of a method for producing ultra-lightweight panels using folded fiber paper sheets and accelerated CO₂ mineralization.

FIGS. 8A, 8B, and 8C illustrate an example ULWP with an origami-based structure.

### DETAILED DESCRIPTION OF SPECIFIC EMBODIMENTS

To fabricate lightweight composites, 3D printing is straightforward but can be relatively slow and expensive. The embodiments described herein provide methods of manufacturing ultra-lightweight concrete (ULWC) through accelerated CO₂ mineralization. CO₂ mineralization, or mineral carbonation, involves the reaction of CO₂ with materials containing alkaline-earth oxides. By curing and packaging the material at different temperatures and pressures, pre-stress can be generated to tailor the thermoelastic properties for specific applications. The ULWC can be manufactured into an ultra-lightweight aggregate (ULWA) or an ultra-lightweight panel (ULWP).

The embodiments described herein pertain to the fabrication of an ultra-lightweight but relatively stiff material, with tailorable thermoelastic properties, such as small thermal expansion coefficient in the range of about −5 to 5×10⁻⁶/° C., so that when the lattice is subject to thermal loading, the corresponding material or structure can behave insensitively to temperature change, which improves the structural safety and stability under extreme weather or large temperature changes.

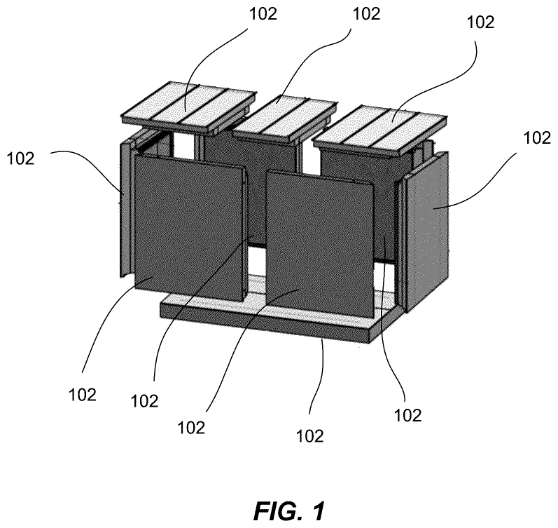

FIG. 1 illustrates an example application of ultra-lightweight concrete (ULWC) for modular manufacturing and construction of large building panels. Using the hierarchically foaming process described herein, fiber-reinforced ULWC may be manufactured with high porosity. By molding and packaging the ULWC into a building panel 102 with fiber reinforcements, large building panels can be fabricated with high R-Value for energy efficiency, acceptable strength for load bearing, and excellent workability for rapid construction. A plurality of the ultra-lightweight panels (ULWP) 102 may be efficiently assembled into a structure with high-standard air, heat, water, and acoustic insulation for rapid construction and holistic energy management.

Foamed concrete is conventionally manufactured by mixing bubbles into cement paste. This direct foaming method uses a surfactant in mixing a liquid with air to produce consistent, stable bubbles. Due to the limits of particle packing efficiency, bubble coalescence is necessary to reach a porosity >74 vol %. However, the large range of bubble size often leads to inconsistent quality of the concrete. Moreover, the stability of bubbles is crucial to keep the lifetime of bubbles longer than 30 minutes after the rheological cement paste is solidified with a C—S—H (calcium-silicate-hydrate) structure.

Conventionally, an open-cell foam material is fabricated by a foaming process with a foaming agent, or a phase replacement method, in which one phase is removed from the composite by melting, dissolving, or etching. Additional material, such as a foaming agent or the residue of the material phase may remain in the foam material. Directly introducing air bubbles into the viscous matrix can be economical but hard to stabilize the bubble size and assure the quality of the material. In addition, for uniform bubble size, due to the limit of particle packing efficiency, the bubble coalescence is necessary to reach a porosity >74 vol %.

Embodiments of a hierarchical foaming process, described herein, promote CO₂ mineralization by replacing air bubbles with CO₂ bubbles through internal CO₂ curing. CO₂ bubbles are introduced twice in fiber-dispersed cement paste to reach a total porosity of >90 vol %, and for more consistent thermomechanical performance, by using bubbles with two different size ranges. The bubbles include nanobubbles with a size range of 200˜1000 nm and microbubbles with a size range of 100-500 μm in diameter. By the specific surface area of a nanobubble (the nanobubble having up to almost 400 times the surface area of a microbubble), the mineralization reaction of CO₂ with a brine paste for carbonation may be accelerated. Afterward, the microbubbles may be introduced to further increase the volume while avoiding the coalescence with nanobubbles.

### Production of Ultra-Lightweight Concrete

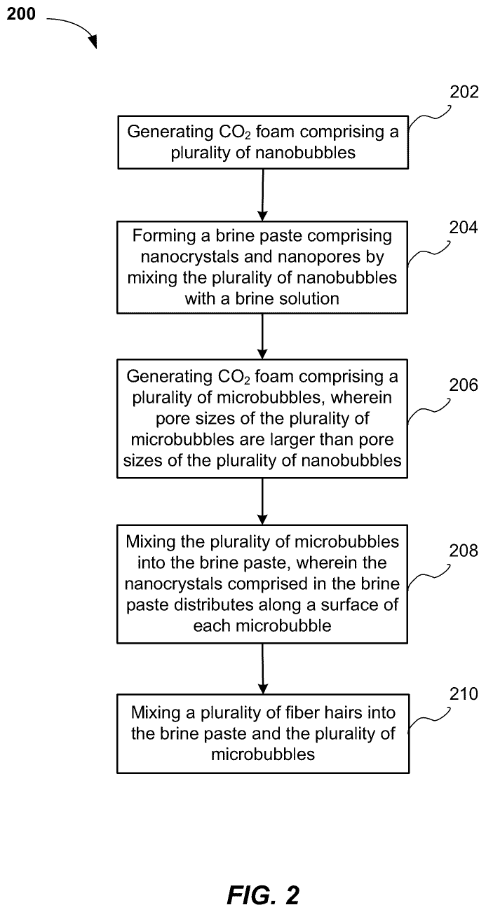

FIG. 2 illustrates a flowchart for a method for producing ULWC using hierarchically CO₂ foaming. In block 202, the method 200 includes generating CO₂ foam comprising a plurality of nanobubbles. For example, using mechanical or acoustic mixing, a foam of CO₂ nanobubbles having a pore size of 200˜1000 nm in diameter may be generated.

In block 204, the method 200 includes forming a brine paste comprising nanocrystals and nanopores by mixing the plurality of nanobubbles with a brine solution. A nanocrystal is a crystalline particle with at least one dimension measuring less than 1000 nm. A nanopore is a pore of nanometer size. Highly saline waters generated by conventional oil and gas recovery activities may be used in the hierarchical foaming process as the brine solution. These highly saline wastewater present environmental challenges, as these effluents are difficult to treat by current water treatment processes. The wastewater with high concentrations of total dissolved solids (TDS) rich in Na+, Mg2+, and Ca2+ ions is particularly useful for CO₂ mineralization, which can reduce the use of cement or other additives to form crystal structures in the ULWC. An example of method 200 reuses the highly concentrated wastewater in ULWC production through accelerated CO₂ mineralization with a high specific area for CO₂ reacting with water and Na+, Mg2+, and Ca2+ ions. For example, the brine solution may include concentrated brine with TDS of 100,000 mg/L to 400,000 mg/L of Na+, Mg2+, and Ca2+ ions to form a paste with nanocrystals and nanopores. Introducing Mg2+ and Ca2+ ions from the water desalination brine to the concrete production process creates an opportunity for carbon neutralization and sustainable material production by reusing wastewater derivatives. As such, a much higher amount of CO₂ can be sequestrated in the building materials for enhanced strength and quality.

Different sources of wastewater, such as brine from desalination of brackish, seawater, and oil and gas (O&G) produced water and decontamination of municipal and industrial wastewater, exhibit different TDS levels and chemical constituents. For quality control of the ULWC production and CO₂ sequestration effectiveness, a TDS >=250,000 mg/L is desirable. When the wastewater sources exhibit TDS <250,000 mg/L, a distillation process, such as multi-stage flash (MSF), mechanical vapor compression (MVC), and multi-effect distillation (MED), can be used to produce more condensate freshwater. To tailor the chemical constituents, cement, quicklime, and/or silica powders may be added to the concentrated brine.

In block 206, the method 200 includes generating CO₂ foam comprising a plurality of microbubbles, wherein the pore sizes of the plurality of microbubbles are larger than the pore sizes of the plurality of nanobubbles. For example, using mechanical or acoustic mixing, foam of CO₂ microbubbles may be generated with a pore size of 100-500 μm. For accelerated CO₂ mineralization, large surface contact between CO₂ gas and mineral-rich brine is desirable. The CO₂ nanobubbles and microbubbles may reach a total porosity of >90 vol %, in which the two different bubble sizes can be stabilized by different mechanisms. By reducing the bubble size with nanofoaming, the specific surface area will allow for rapid, sufficient mineralization reaction of CO₂ with cement paste for carbonation. The introduction of the microbubbles further increases the volume while minimizing coalescence with the nanobubbles.

In block 208, the method 200 includes mixing the plurality of microbubbles into the brine paste, wherein the nanocrystals comprised in the brine paste distribute along the surface of each microbubble.

In block 210, the method 200 includes mixing a plurality of fiber hairs into the brine paste and the plurality of microbubbles. For example, the fiber hairs may include short fibers of approximately 5 mm in length.

The mixture that includes the fiber hairs, brine paste, and microbubbles then cures and solidifies into ULWC. The nanocrystals and fibers stabilize the microbubbles, which form a porous microstructure with carbonate crystals. The ULWC may then be cut into cuboids or spherical balls to form ultra-lightweight aggregates (ULWA), whose sizes can be controlled by the cutting mold for specific needs of construction or other applications. Because the carbonation of the minerals may consume a high amount of CO₂, although the CO₂ nanobubbles and microbubbles enable accelerated CO₂ mineralization to form the stable microstructure, when the CO₂ in the bubbles is not enough to react with the metal ions, the carbon mineralization process may continue for a longer period while absorbing more CO₂ from the ambient air.

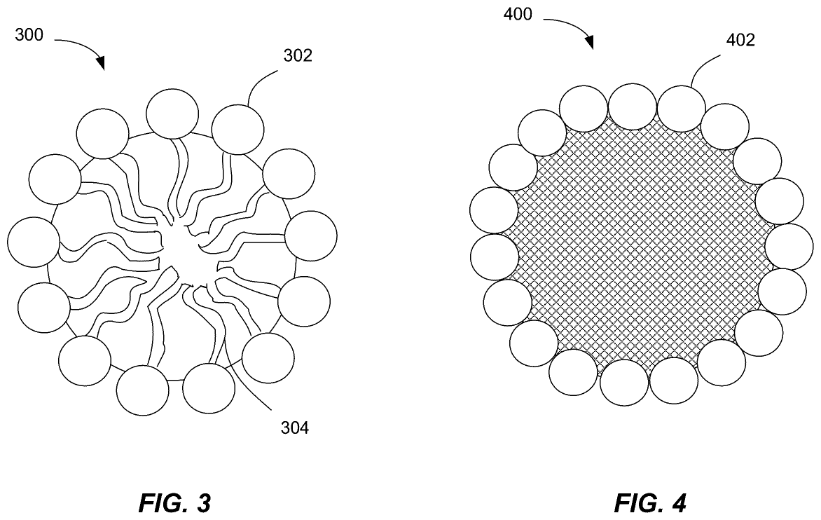

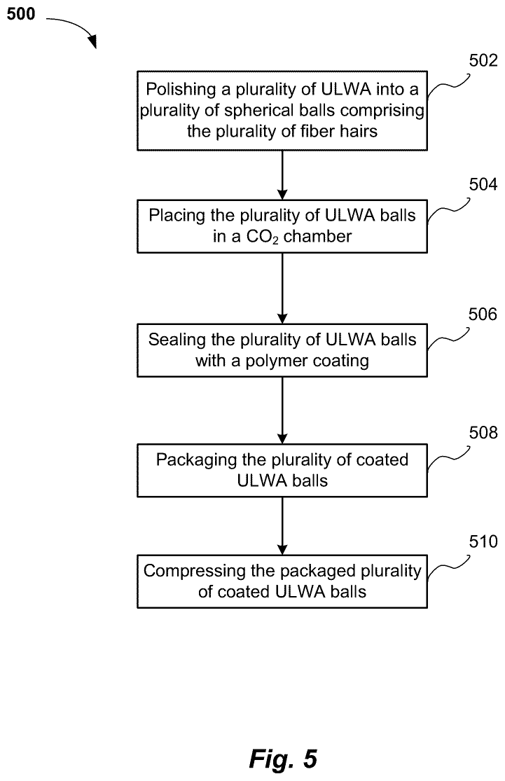

Referring to FIG. 3, CO₂ nanobubbles 300, with hydrophilic heads 302 and hydrophobic tails 304, are produced by mixing surfactant and an amphiphilic polymer stabilizer with an ultrasonic foaming process under controlled vacuum and temperature to stabilize the pore size at 200˜1000 nm. The CO₂ nanobubbles 300 are mixed into the brine paste and react with the metal ions during the carbonation reaction. As a result, many nanocrystals will be formed from the carbonation process. Referring to FIG. 4, stable CO₂ microbubbles 400 with high zeta potential (up to −27 mV) may be generated by mixing foaming surfactant solution in a foaming machine under a certain pressure of 2-3 bars to form a pore size at 100-500 μm. When the microbubbles are mixed into the brine paste, the nanocrystals 402 may be distributed along the surface of the microbubbles 400 for Pickering stabilization.

The method 200 may provide certain advantages. For example, in conventional concrete manufacturing, the ambient CO₂ concentration (˜0.04%) is too low to enable efficient CO₂ curing. Thus, the existing CO₂ curing of concrete is highly dependent on a carbon chamber to provide CO₂ which reacts with concrete through surface contact. However, the mandatory use of a carbon chamber in CO₂ curing of concrete will greatly limit its application in practice because of the carbonation speed and the required equipment. The method 200, however, does not require the use of a carbon chamber. Instead, the method 200 directly produces foam using CO₂ gas. Instead of exposing the finished material to CO₂ in a chamber, CO₂ is directly injected into the brine paste to make CO₂ foam. When a large volume of CO₂ foams is to be consumed during the mixing and curing process, conducting the manufacturing process in a CO₂ chamber with temperature and moisture control may maximize and accelerate the carbonation process, and form metal carbonates for enhanced strength and carbon retention. Moreover, in conventional concrete manufacturing, the surface contact between CO₂ and cement paste is limited, which slows down the mineralization process. In contrast, the CO₂ curing with the method 200 occurs with a large specific surface ratio crucial for maximized carbonation during its life cycle. This not only permanently stores CO₂ in the ULWA, but also increases the material strength and efficiency. By introducing more Mg and Ca oxides into the ULWC production, which are present at high concentrations in desalination wastewater, opportunities for carbon neutralization and sustainable material production are provided. In addition, the hierarchical CO₂ foaming process with fibers creates a cellular lattice microstructure. With accelerated CO₂ mineralization, the microstructure may be stabilized. Therefore, even if CO₂ is consumed in the carbonation process, the material will retain the same shape, and further carbonation can be resumed with the CO₂ intake from the ambient air. Silicone surfactant, which is a common surface agent in the industry, not only stabilizes the CO₂ bubbles from coarsening but also enhances the CO₂ absorption into the concrete. Therefore, the CO₂ can be retained in the panel for higher strength and stiffness of the panel.

Producing Ultra-Lightweight Aggregate from Ultra-Lightweight Concrete

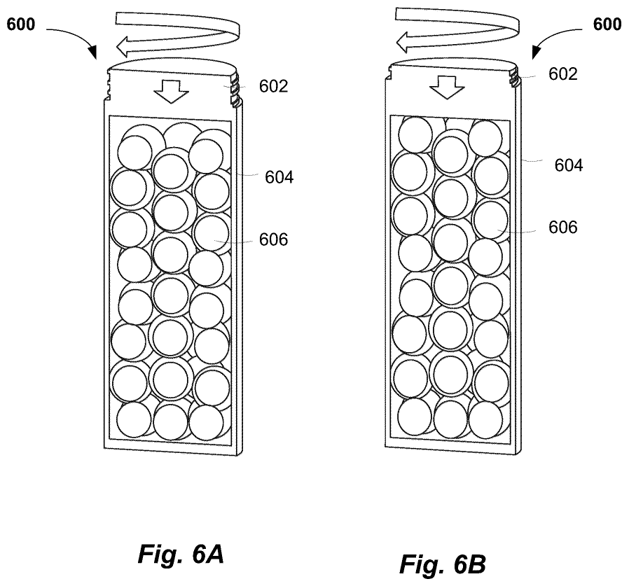

The ULWA formed using the ULWC may be packed into another form, such as an ultra-lightweight panel ULWP. FIG. 5 illustrates a flowchart of a method for producing packaged ULWA. In block 502, the method 500 includes polishing a plurality of ULWA into a plurality of spherical balls comprising the plurality of fiber hairs. For example, a dry impact blending method, used in the pharmaceutical industry to precisely control the pill's size and shape, may be used to polish ULWC particles into a spherical shape to form the ULWA balls. Since the cement is brittle, the angular edges will be removed in the dry impact blending process, but the fibers inside will remain as hairs on the surface of the ULWA balls. When a polymer coating, such as epoxy, polyaspartic, or polyurea, is sprayed onto the ULWA balls as they roll, the hairs may cause the coating to adhere tightly to the lattice. During the material curing, high-pressure air may be sealed inside the ULWA balls, making the ULWA balls very stiff yet lightweight due to the volume increase.

In block 504, the method 500 includes placing the plurality of ULWA balls into a CO₂ chamber. For example, the ULWA balls may be placed into the CO₂ chamber at a pressure of 5˜8 psi.

In block 506, the method 500 includes sealing the plurality of ULWA balls with a polymer coating. For example, the ULWA balls may be sealed at a certain diameter by polymer coating at a pressure of 1.2˜5 bars. The thermal expansion coefficient (CTE) can be tailored by the pressure, and a small thermal expansion coefficient in the range of about −5 to 5×10⁻⁶/° C. may be achieved.

In block 508, the method 500 includes packaging the plurality of coated ULWA balls. For example, the coated ULWA balls may be packaged in a CO₂ chamber.

In block 510, the method 500 includes compressing the packaged plurality of coated ULWA balls. For example, the ULWA balls may be packaged into a mold to form the ULWA balls into a shape, such as a panel to form a ULWP or into columns. The ULWP or columns are then cured.

The ULWA balls may be sealed at a certain pressure to reach small CTE with an airproof coating. Although the ULWA balls may be made of ordinary cellular lattices with a surface coating, the density of the ULWA balls may be 4-25% of the corresponding pure solid. The effective stiffness and thermal expansion coefficient may be controlled by the pressure during the fabrication of the ULWA balls. The bond length of the cellular lattice, the size of the ULWA ball, and the thicknesses of the coating and forming layers can be calculated and designed for specific applications.

With temperature changes, the stiffness and size of the ULWA balls will change, which may be controlled by the curing pressure and the polymer coating thickness. The temperature-dependent effective stiffness and thermal expansion coefficient can be designed for unique thermoelastic behaviors. In addition, the resulting products may sustain large deformation exhibiting high energy absorption capability. The ULWA balls can be used for particulate composites, filling materials for shipping, and protective materials for vehicles, ships, and aircraft.

Larger ULWA balls may be formed using smaller ULWA balls filled into a spherical shell. By repeating the process multiple times, larger ULWA balls with an acceptable stiffness can be made by adjusting the pre-tension during each packaging step. The larger ULWA balls may be used for larger structures with higher material efficiency requirements.

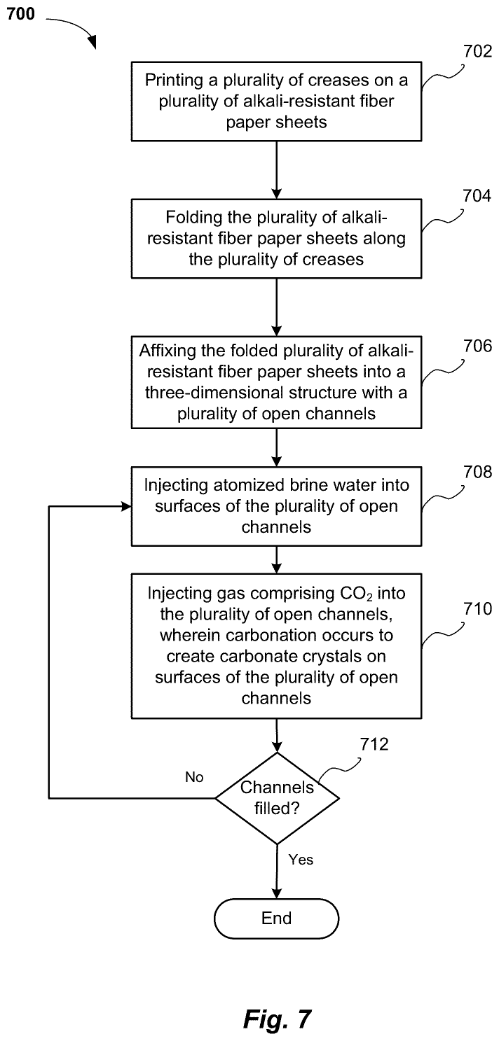

FIGS. 6A-6B illustrate applying pre-tension to a composite 600 of ULWA balls 606. The application of pre-tension is described in the context of ULWA balls 606 residing in a tube-shaped container 604 for purposes of illustration. The ULWA balls 606 may reside in containers of other shapes and sizes, with pre-tension applied in the same or similar manner. Referring to FIGS. 6A and 6B, the application of pre-tension is represented by the linear motion of a screw cap 602 at an open end of the tube-shaped container 604. In FIG. 6A, the screw cap 602 does not contact the ULWA balls 606. The screw cap 602 may be turned to adjust the linear motion of the screw cap 602 into the tube-shaped container 604 until the screw cap 602 contacts the ULWA balls 604. By adjusting the level of linear motion of the screw cap 602, pressure is applied to the ULWA balls 604 while the tube-shaped container 604 is under tensile force. This significantly changes the stiffness and thermal expansion coefficient of the composite 600 by the configurational force during the deformation of the ULWA balls 604, which can be quantified through the Singum model. A continuum particle model correlates the interatomic potential of a crystal lattice with the elastic moduli of the solid, in which discrete atoms are modeled by perfectly bonded continuum particles, named Singum, to simulate singular forces by stress in the continuum. A Singum particle occupies the space of the Wigner Seitz (WS) cell of the atom lattice. The Singum model uses the WS cells of a lattice to represent a continuum solid, so that the singular forces can be transformed into the contacting stress between the continuum particles. By applying a virtual displacement, from the relationship between the virtual stress and strain, the elastic constants are obtained.

### Producing Origami-Based Ultra-Lightweight Panels

For a ULWP, the fiber reinforcements can be in the form of fiber mesh or sheet with a structured fiber distribution to avoid fiber mixing, which can be agglomerated. Origami techniques, which originated as a folding paper art, may be applied to form metamaterial with configurable shapes. The origami-based structure may be formed using fiber sheets, which may be in the form of paper sheets with a certain treatment, such that the folded fiber sheets maintain their shape, even in high humidity. Using multiple sheets with mirror projections, the two-dimensional (2D) sheets can be folded into a larger volume in the three-dimensional (3D) space.

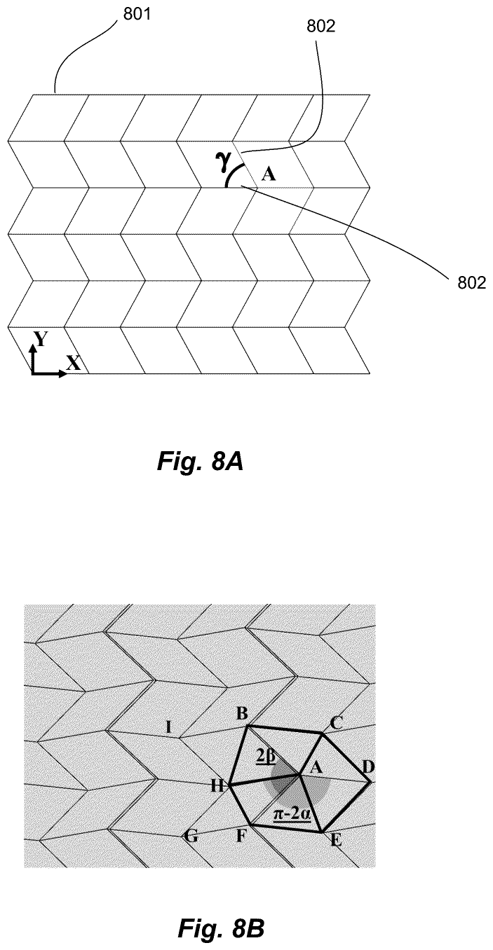

FIG. 7 illustrates a flowchart of a method for producing ULWP using folded fiber paper sheets and accelerated CO₂ mineralization. In block 702, the method 700 includes printing a plurality of creases on a plurality of alkali-resistant fiber paper sheets. For example, the paper may be stable at a pH value of 13.

In block 704, the method 700 includes folding the plurality of alkali-resistant fiber paper sheets along the plurality of creases.

In block 706, the method 700 includes affixing the folded plurality of alkali-resistant fiber paper sheets into a three-dimensional structure with a plurality of open channels. For example, the origami sheets may be folded and glued along the creases with polyurethane or other types of adhesive. A 3D structure with many zigzag channels is thus formed. The origami-based structure may be packaged into a panel box with two of the channel access ends open and the other sides sealed.

In block 708, the method 700 includes injecting atomized brine water into the plurality of open channels. For example, the atomized brine mist may be introduced at the open end of the channels to wet the 3D structure until saturation of the paper sheets, so that the metal ions are on the surfaces of the folded and glued fiber paper sheets.

In block 710, the method 700 includes injecting gas comprising CO₂ into the plurality of open channels, wherein carbonation occurs to create carbonate crystals on surfaces of the plurality of open channels.

In block 712, the method 700 includes repeating blocks 708 and 710 until the plurality of channels are filled with carbonate crystals. For example, this process may be used for onsite CO₂ capture. When onsite CO₂ capture is not required, the brine paste with CO₂ bubbles is directly pumped into the open channels of the folded paper sheets to form ultra-lightweight concrete panels. The two opening sides of the panel may then be trimmed to obtain a clean ULWP.

Forming the fiber network into a layered origami-based structure with channels enables direct CO₂ capture with concentrated brine. The ULWP may exhibit high performance in heat, moisture, and acoustic insulation with the layered structure. Due to the rigid body motion mode of the origami panels without local strain, the ULWP can keep the integrity of the interface between the panels under temperature variation, and thus, enhance the building energy efficiency. High CO₂ content may be reached in the ULWP with metal carbonation.

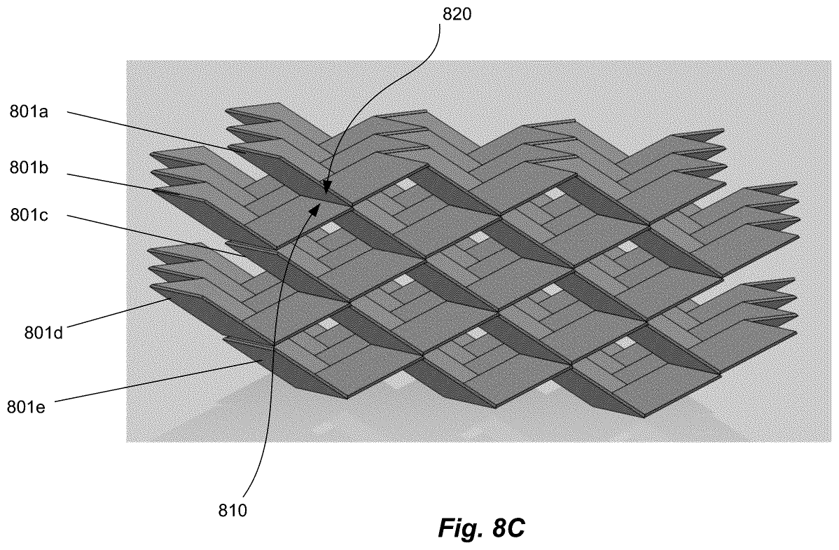

FIGS. 8A and 8B illustrate an example ULWP with an origami-based structure. Referring to FIG. 8A, creases 802 may be created onto fiber paper sheets 801 with an angle γ=60° (π/3 rad) to form a folding pattern. As shown in FIG. 8B, the folding pattern may include mountain creases AB, AF, AD that form ridges and valley creases AH, HI, HG that form trenches. The folding pattern may be extended to the whole fiber paper sheet. The creases AB, AF, AD, AH HI, HG may share the same crease length α. During the folding process, the angle 28=LBAF reduces from 120° (2π/3 rad) to zero, and it −2α=¿BAF reduces from 180° (π rad) to 60° (π/3 rad), so both α and β change in a range of 0 to 60° (0 to π/3 rad) and satisfy cos α. cos β=0.5 during the folding process. As illustrated in FIG. 8C, multiple folded sheets 801a, 801b, 801c, 801d, 801e, may be glued together, with a mountain crease of the lower layer (e.g., mountain crease 810 of layer 801b) onto a valley crease of the upper layer (e.g., valley crease 820 of layer 801a), to form a 3D structure. Around the glued zigzag lines of IHG or BAF, four zigzag channels are formed along the line. When α=38° (0.66 rad), the density of the 3D structure may be minimized with the largest volume. The specific surface area can be adjusted by the crease length and folding angle. For example, for a crease length α=5 to 15 mm, given α and β, the specific area S_{ν} can be derived for a unit cell using Equation 1:

$${S}_{v} = \frac{2 {A}_{BIHGFEDC}}{V} = \frac{4 * \sqrt{3} {a}^{2}}{2 a cos α * 2 a sin β * a sin α} = \frac{\sqrt{3}}{a cos α * sin α * sin β} \qquad ( Eq . 1 )$$

S_{ν} increases when a decreases because multiple sheets can be used in the same unit cell. The higher the specific area S_{ν}, the more CO₂ can be in contact with the metal ions for accelerated CO₂ mineralization.

The sizes of ULWP may change with the folding angle, and α≅38° (0.66 rad) may be used to realize the highest volume. The carbonate crystal structure may grow onto the surface of the fiber paper sheets and fill the channels for the ULWP to have high strength yet be lightweight. The effective stiffness of the ULWP may be tailored by the fiber paper sheet thickness and length of the creases in the folding pattern.

### Quantitative Prediction of Effective Stiffness

The effective stiffness of cellular and granular lattices depends on the lattice structures. In engineering applications, some defects may easily distort the lattice in such a way that although on the microscale the material still exhibits a certain structure, the orientation of the lattice structure may vary significantly on the macroscale. This may lead to an isotropic symmetry with two independent elastic constants, i.e., shear modulus and bulk modulus, from which any isotropic elastic constants can be derived including Young's modulus and Poisson's ratio.

For cellular lattices made of linear elastic bonds, given the Young's modulus (E) and density (p) of the bond material, the effective elastic moduli depend on the effective density (p̅) and stretch ratio (λ) of the bonds as:

$${K}^{cell} = \frac{E ( 2 - λ )}{9 ρ} \overline{ρ} \qquad ( Eq . 2 )$$

$${μ}^{cell} = \frac{E ( 5 λ - 4 )}{15 ρ} \overline{ρ} \qquad ( Eq . 3 )$$

where K^{cell} and μ^{cell} indicate the effective bulk and shear moduli, respectively.

For granular lattices made of linear elastic balls with the Young's modulus (E) and Poisson's ratio (v), if the balls are manufactured at the maximum packing efficiency of 74%, the effective elastic moduli depend on the packing efficiency and stretch ratio (λ) of the bonds as:

$${K}^{gran} = \frac{\sqrt{2} E}{9 ( 1 - {v}^{2} )} {( 1 - λ )}^{1 / 2} ( 4 - λ ) \qquad ( Eq . 4 )$$

$${μ}^{gran} = \frac{\sqrt{2} E}{15 ( 1 - {v}^{2} )} {( 1 - λ )}^{1 / 2} ( 11 λ - 8 ) \qquad ( Eq . 5 )$$

where K^{gran} and μ^{gran} indicate the effective bulk and shear moduli, respectively.

Reference in this specification to “one embodiment,” “an embodiment,” “an exemplary embodiment,” “some embodiments,” “example embodiments,” or “a preferred embodiment” means that a particular feature, structure, or characteristic described in connection with the embodiment is included in at least one embodiment. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments. In general, features described in one embodiment might be suitable for use in other embodiments as would be apparent to those skilled in the art.

It should be understood that the exemplary embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from their spirit and scope.

The terminology used herein is for the purpose of describing particular embodiments only and is not intended to be limiting to the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The embodiments of the invention described above are intended to be merely exemplary; numerous variations and modifications will be apparent to those skilled in the art. All such variations and modifications are intended to be within the scope of the present invention as defined in any appended claims.

What is claimed is:

1. A method for producing ultra-lightweight concrete, comprising:
generating carbon dioxide (CO₂) foam comprising a plurality of nanobubbles;
forming a brine paste comprising nanocrystals and nanopores by mixing the plurality of nanobubbles with a brine solution;
generating the CO₂ foam comprising a plurality of microbubbles, wherein pore sizes of the plurality of microbubbles are larger than pore sizes of the plurality of nanobubbles;
mixing the plurality of microbubbles into the brine paste, wherein the nanocrystals comprised in the brine paste distribute along a surface of each microbubble; and
mixing a plurality of fiber hairs into the brine paste and the plurality of microbubbles.

2. The method of claim 1, wherein the plurality of nanobubbles each comprise a pore size of 200˜1000 nm.

3. The method of claim 1, wherein the plurality of microbubbles each comprise a pore size of 100-500 μm.

4. The method of claim 1, further comprising:
cutting the ultra-lightweight concrete into balls to form a plurality of ultra-lightweight aggregate (ULWA).

5. The method of claim 4, further comprising:
polishing the ULWA into a plurality of spherical balls comprising the plurality of fiber hairs;
placing the plurality of ULWA balls into a CO₂ chamber with pressure at 1.2-5 bars;
sealing the plurality of ULWA balls with a polymer coating; and
packaging the plurality of coated ULWA balls.

6. The method of claim 5, further comprising:
compressing the packaged plurality of coated ULWA balls in a mold.

7. A method for producing ultra-lightweight concrete panels, comprising:
printing a plurality of creases on a plurality of alkali-resistant fiber paper sheets;
folding the plurality of alkali-resistant fiber paper sheets along the plurality of creases;
affixing the folded plurality of alkali-resistant fiber paper sheets into a three-dimensional structure with a plurality of open channels;
injecting atomized brine water into surfaces of the plurality of open channels; and
injecting gas comprising CO₂ into the plurality of open channels, wherein carbonation occurs to create carbonate crystals on the surfaces of the plurality of open channels.

8. The method of claim 7, further comprising:
repeating the injecting of the atomized brine water and the injecting of the gas comprising CO₂ until the plurality of open channels are filled with carbonate crystals.

9. The method of claim 7, further comprising:
determining that the injecting of the atomized brine water and the injecting of the gas comprising CO₂ does not require onsite CO₂;
generating CO₂ foam comprising a plurality of nanobubbles;
forming a brine paste comprising nanocrystals and nanopores by mixing the plurality of nanobubbles with a brine solution;
pumping the brine paste into the plurality of open channels until the plurality of open channels are billed with carbonate crystals.
